(19) United States
(12) Patent Application Publication
(10) Pub. No.: US 2006/0100930 A1
(43) Pub. Date: May 11, 2006

(54) Method and system for advertising

(76) Inventor: Jody L. Novak-Torre, Lafayette, NJ (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 11/313,479

(22) Filed: Dec. 19, 2005

Related U.S. Application Data
(63) Continuation-in-part of application No. 10/693,472, filed on Oct. 23, 2003.
(60) Provisional application No. 60/642,188, filed on Jan. 7, 2005.

(51) Int. Cl. G06Q 30/00

(52) U.S. Cl. 705/14

(57) ABSTRACT

A system and method for communicating advertisements to potential consumers by providing a combination of hard-copy and electronic media. The system and method feature a main console having a rack for displaying hard-copy promotional items, such as business cards, in visual proximity to at least one electronic display. The electronic display broadcasts electronic media, such as video or still images, related to the hard-copy promotional items. The advertising system may include multiple consoles arranged in a multi-sided configuration. In addition, the advertising system may be interactive in that it allows a user to select the electronic media to be displayed. Further, the console or consoles may be sized such that they may be arranged on a table-top or mounted on a wall or other surface.

### CROSS-REFERENCE TO RELATED APPLICATIONS

This application is a continuation-in-part of U.S. patent application Ser. No. 10/693,472, filed on Oct. 23, 2003. This application also claims the benefit of U.S. Provisional Application No. 60/642,188, filed on Jan. 7, 2005. The entire disclosures of U.S. patent application Ser. No. 10/693,472 and U.S. Provisional Application Ser. No. 60/642,188 are incorporated by reference herein.

### FIELD OF THE INVENTION

This invention relates generally to advertising, and, more particularly, to an method and system for advertising combining hard-copy and electronic advertisements.

### BACKGROUND OF THE INVENTION

It has become increasingly difficult to reach consumers within today's fast paced culture and cluttered shopping environments. Advertisers are continually searching for new ways to effective communicate with potential consumers.

One conventional form of advertising includes the display of hard-copy promotional items, such as, for example, business cards, brochures, or other piece of printed literature, relating to a variety of often dissimilar advertisers and/or products, on a single display rack. For example, diners, hotels and other similar establishments often feature such a display rack in a reception area or lobby. Advantageously, these display racks enable advertisers to reach potential customers who do not physically visit the advertiser's own place of business.

However, a disadvantage of these display racks is that they are often overlooked by potential consumers when arranged in a busy environment. Another disadvantage is that the display racks provide only hard-copy promotional items, which often lack the cogency and communication power of other more visually stimulating media, such as electronic media.

Another disadvantage is that display of the hard-copy promotional items is static in nature, with no ability to control or manage the amount or level of a viewer's exposure to a particular advertiser or product.

Also absent from the art is an advertising system which allows a potential consumer to select specific advertisers or products about which he or she wishes to receive additional information.

Further, in construction, conventional display racks are viewable from a limited perspective. Specifically, the hard-copy promotional items are accessible and viewable from only a position directly in front of the rack and not from a side or rear perspective.

Therefore, there is a need in the art for a method and a system for reaching potential consumers in a versatile, interact manner.

### SUMMARY OF THE INVENTION

Embodiments of the present invention satisfy these and other needs by providing an advertising system that displays hard-copy and electronic media to a potential consumer in a single location. According to an embodiment of the present invention, the advertising system includes a main console having one or more main visual displays (e.g., a full motion digital screen) combined with a display rack adapted to display one or more hard-copy promotional items (e.g., business cards, brochures, any type of printed literature, etc.).

The one or more visual displays are in visual proximity to the display rack, and are configured to display electronic media (e.g., advertisements) related to the one or more advertisers/products associated with the hard-copy promotional items. According to an embodiment of the present invention, the advertising system may include one or more auxiliary screens in visual proximity to the main console. Like the main visual display, the one or more auxiliary displays are configured to display electronic media (e.g., advertisements) related to the one or more advertisers/products associated with the hard-copy promotional items.

The advertising system further includes a server configured to manage and control the electronic media displayed by the one or more main consoles connected thereto.

According to an embodiment of the present invention, a user may interact with the advertising system to select the electronic media to be displayed by the visual display(s). The one or more main consoles may include an input device wherein the user may enter an advertiser and/or product-specific identifier which results in the display of electronic media related to that advertiser and/or product.

According to an embodiment of the present invention, the main console may be any suitable shape or size, including, but not limited to, a main console adapted to be placed on a table-top or mounted on a wall.

According to an embodiment of the present invention, the advertising system may include multiple main consoles arranged in a multi-sided configuration. Advantageously, the multi-sided advertising system may be viewed from a variety of viewing angles and perspectives.

### BRIEF DESCRIPTION OF THE DRAWINGS

The present invention will be more readily understood from the detailed description of exemplary embodiments presented below considered in conjunction with the attached drawings, of which:

FIG. 1 depicts an exemplary advertising system, according to an embodiment of the present invention;

FIG. 2 depicts a side perspective view of an exemplary main console of an advertising system, according to an embodiment of the present invention;

FIG. 3 depicts a back view of an exemplary main console of an advertising system, according to an embodiment of the present invention;

FIGS. 4 and 5 depict side views of an exemplary main console of an advertising system, according to an embodiment of the present invention;

FIG. 6 depicts a top view of an exemplary main console of an advertising system, according to an embodiment of the present invention;

FIG. 7 depicts a bottom view of an exemplary main console of an advertising system, according to an embodiment of the present invention;

FIG. 8 depicts an exemplary advertising environment, according to an embodiment of the present invention;

FIG. 9 depicts an interactive advertising system including a plurality of visual displays, according to an embodiment of the present invention; and

FIG. 10 depicts a multi-sided interactive advertising system, according to an embodiment of the present invention.

It is to be understood that the attached drawings are for purposes of illustrating the concepts of the invention and may not be to scale, and are not intended to be limiting in terms of the range of possible shapes and/or proportions.

### DETAILED DESCRIPTION OF THE INVENTION

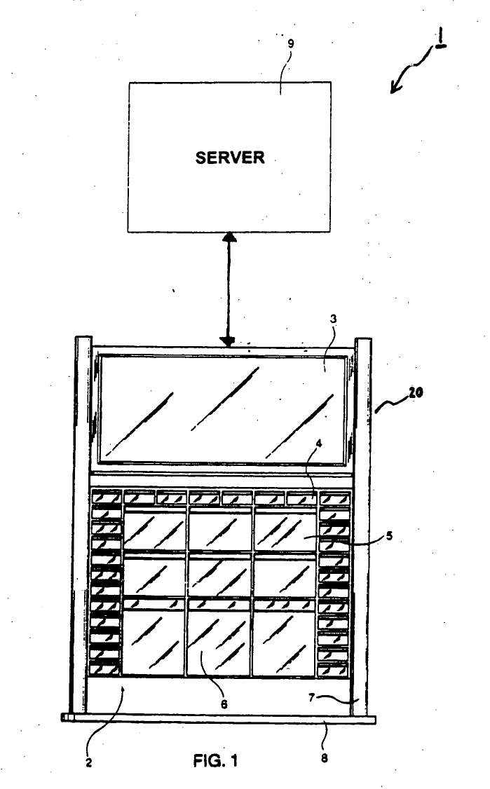

FIG. 1 illustrates an exemplary advertising system 1 according to an embodiment of the present invention. As shown in FIG. 1, the advertising system 1 comprises a main console 20 communicatively connected to a server 9. The term “communicatively connected” is intended to include any type of connection, whether wired or wireless, in which data may be communicated. The term “communicatively connected” is intended to include a connection between devices and/or programs within a single computer or between devices and/or programs on separate computers. For example, the main console 20 and the server 9 may be connected via any suitable network, including, but not limited to a Wide Area Network (WAN) or Local Area Network (LAN).

According to an embodiment of the present invention, the main console 20 includes, but is not limited to, a display rack 2 in visual proximity to a main visual display 3. The display rack 2 is configured to display a plurality of hard-copy promotional items (e.g., business cards, brochures, etc.). The display rack 2 allows a user to locate and retrieve specific hard-copy promotional items related to a specific advertiser/product of interest.

According to an embodiment of the present invention, the display rack 2 may include an array of slots 4, 5, 6 for holding and displaying the hard-copy promotional items. As shown, the slots 4, 5, 6 may be shaped and sized to display hard copy-promotional items of varying shapes and sizes. For example, slot 4 may display a conventional business card-sized z-fold hard copy promotional item, slot 5 may display a postcard-sized hard-copy promotional item, and slot 6 may display a brochure-sized hard-copy promotional item. One having ordinary skill in the art will appreciate that the other sized and/or shaped slots may be used in accordance with the present invention. In addition, the display rack 2 may comprise slots of a uniform or single size and shape.

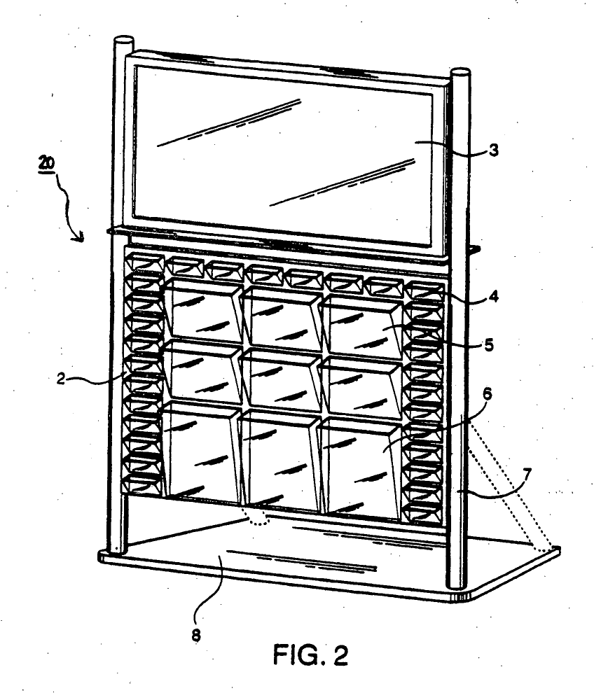

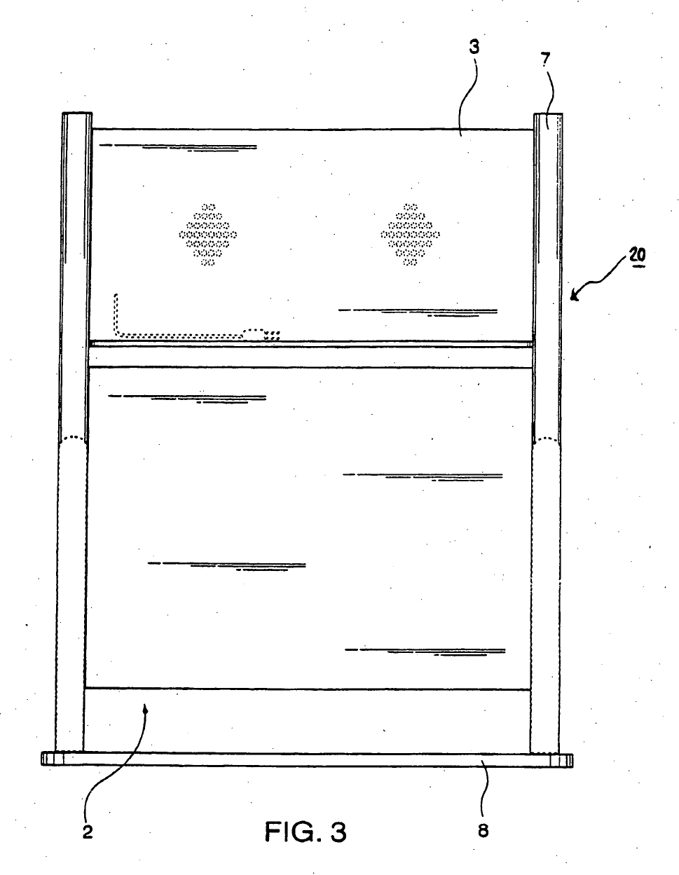

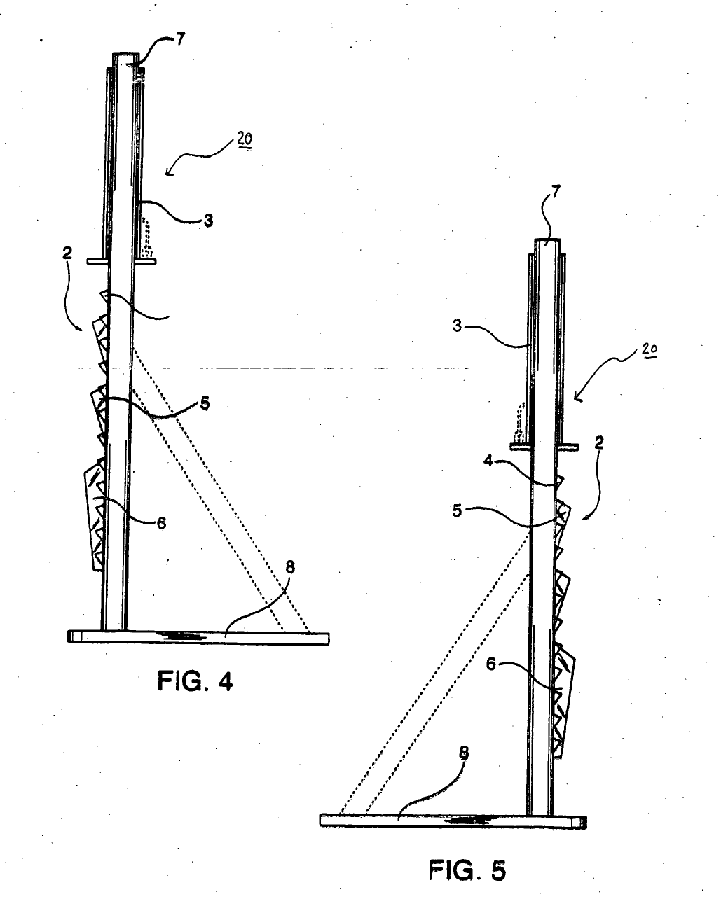

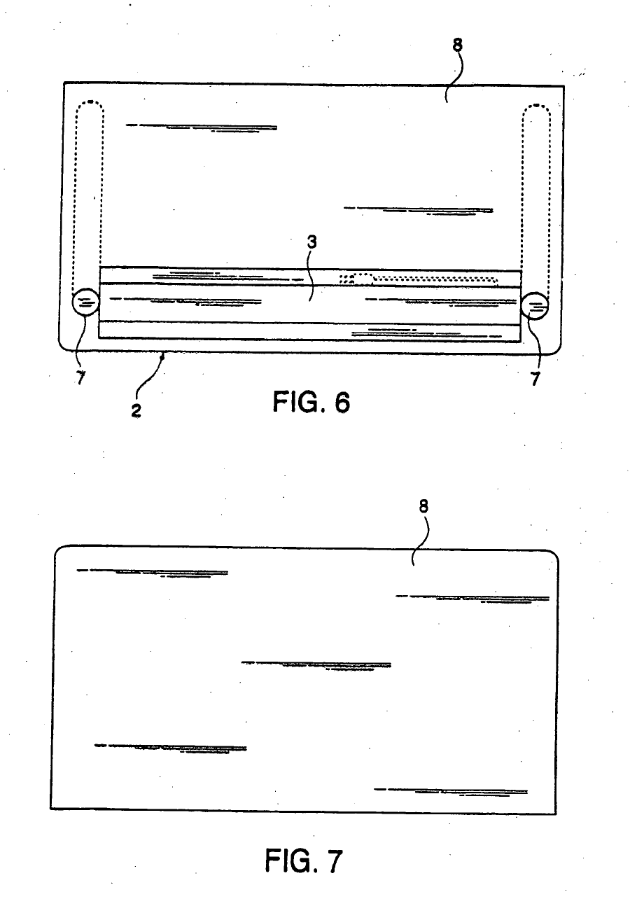

As shown in FIGS. 1-7, the main console 20 includes a main visual display 3 arranged in visual proximity to the display rack 2. The main visual display 3 may include any suitable electronic display device, such as, preferably, a television or monitor.

The main visual display 3 is configured to display electronic media related to the one or more advertisers/products associated with the hard-copy promotional items displayed by the display rack 2. Optionally, the main console 20 may include a frame 7 which allows for the physical attachment of the display rack 2 and the main visual display 3. In addition, the main console 20 may include a base 8 to allow the main console 20 to be arranged in an upright, standing position.

The main visual display 3 is configured to accept and display electronic media received from the communicatively connected server 9. The electronic media communicated by the server 9 to the main visual display 3 may include, but is not limited to, an audio and/or video stream (e.g., a moving-image commercial or other advertisement) and/or one or more still images. One having ordinary skill in the art will appreciate that the main visual display 3 may include any data processing device, such as a desktop computer, a laptop computer, a mainframe computer, a personal digital assistant, a server, a central processing unit, or any other device able to receive and display the electronic media. Optionally, the main console 20 may include one or more sound producing devices, such as a speaker, communicatively connected to the server 9 and/or the main visual display 3 and configured to which capable of playing sound is associated with the electronic media.

Advantageously, the advertising system 1 provides a viewer with both electronic media and a hard-copy promotional item at a single location. By providing both at the same location, the advertising system 1 is able to effect the emotional cogency of a broadcast advertisement, and then psychologically anchor that emotional cogency with a tangible hard-copy promotional item which preserves that emotional cogency over time.

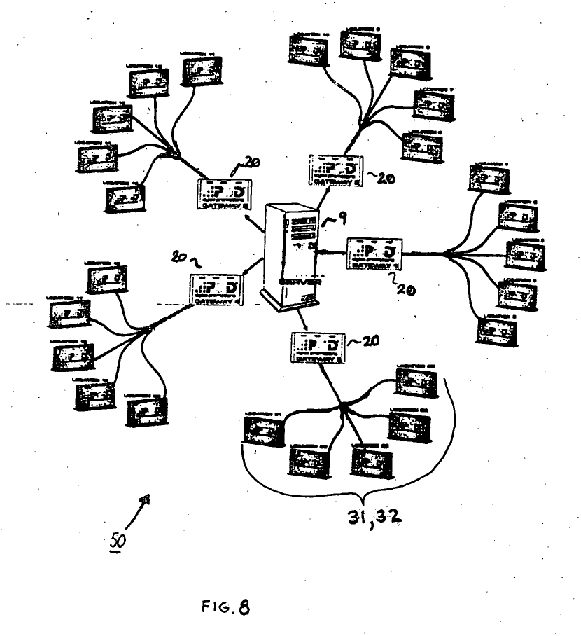

FIG. 8 shows an exemplary advertising environment 50 according to an embodiment of the present invention, wherein a plurality of geographically dispersed main consoles 20 are communicatively connected to the server 9. One having ordinary skill in the art will appreciate that one or more auxiliary displays 31, 32 may be communicatively connected to each of the one or more main consoles 20 and/or the server 9.

According to an embodiment of the present invention, the server 9 is any suitable computer known in the art that may be configured to control and manage the electronic media. Specifically, the server 9 determines what electronic media is displayed on each of the one or more main consoles 20 communicatively connected in the environment 50.

According to an embodiment of the present invention, the server 9 may deliver geographic-specific electronic media to each of the main consoles 20. For example, electronic media relating to a plumber based in Anytown, N.J. may be selectively administered to only the main consoles 20 located in the towns and/or cities geographically proximate to Anytown, N.J., while electronic media relating to a nationwide real estate brokerage firm may be sent to all the main consoles 20 in the environment 50. In addition, the server 9 may control the frequency and timing of the electronic media displayed on the one or more main consoles 20, for example, according to a schedule.

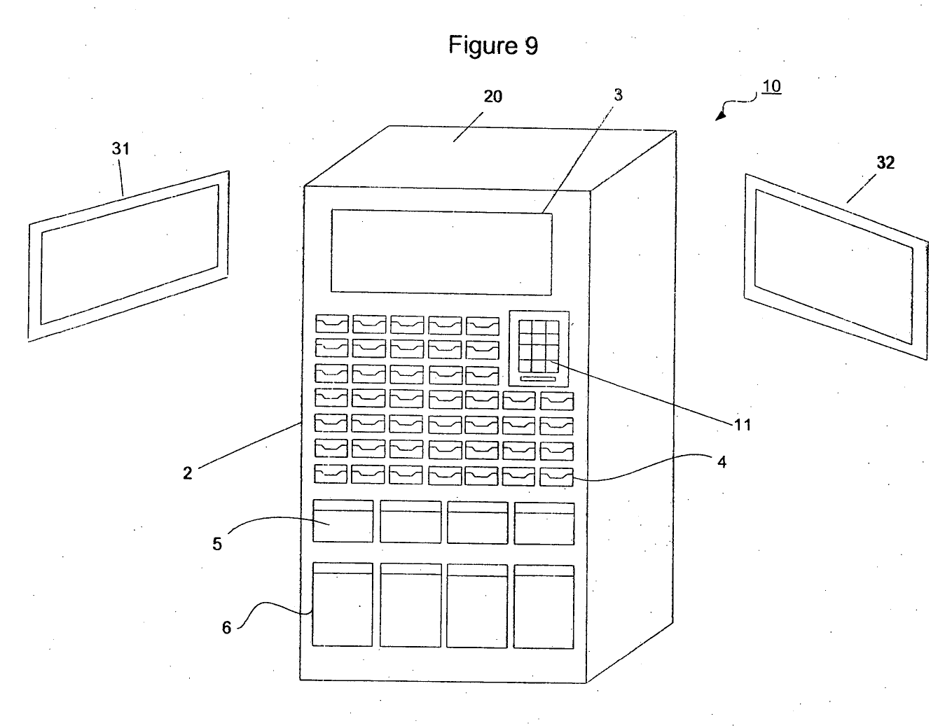

FIG. 9 illustrates an exemplary advertising system 10 according to another embodiment of the present invention, wherein the advertising system 10 comprises a main console 20 (as described in detail above) in visual proximity to one or more auxiliary displays 31, 32, all of which is communicatively connected to a server 9 (not shown). Like the main visual display 3, the auxiliary displays 31, 32 may be any visual display device, including, but not limited to, a flat panel screen or monitor.

The auxiliary displays 31, 32 display the electronic media received from the server 9, which may include the same or different images/video as those shown on the main visual display 3. For example, the main visual display 3, auxiliary display 31, and auxiliary display 32 may each display a unique segment or portion of a single electronic media feed, such that, when viewed together, the main and auxiliary displays 3, 31, 32 provide the entire feed to a viewer.

Like the main visual display 3, the auxiliary displays 31, 32 may be any shape and/or size, may include a sound producing device (e.g., a speaker), and/or may be a color or black and white display. While FIG. 9 depicts two auxiliary displays 31, 32, one having ordinary skill in the art will appreciate that the advertising system 10 may include any number of auxiliary displays may be used, including a single auxiliary display. In addition, one having ordinary skill in the art will appreciate that the auxiliary displays 31, 32 may be arranged in any visually proximal location relative to the main console 20.

According to an embodiment of the present invention, the advertising system 10 may also include an input device 11 that allows a user to interact with the advertising system 10. Specifically, using the input device 11, a user may request or select the electronic media to be displayed by entering a code (i.e., a numeric or alphanumeric character string), a name, or other identifying information, collectively referred to as an “advertiser-specific identifier,” that corresponds to a specific advertiser and/or product associated with the system 10. Upon entry of the advertiser-specific identifier into the input device 11, the appropriate electronic media is displayed, on-demand, on one or more of the displays 3, 31, 32. The advertiser-specific identifiers may be located on the hard-copy promotional items, on the card rack 2 itself, in an image displayed on the main display 3 and/or auxiliary displays 31, 32, or other suitable location.

Advantageously, the advertiser-specific identifier may be used as a mechanism to pique the interest of a potential consumer. For example, a graphic or image displayed by the advertising system 10 may include a statement such as “enter promotional code 256 to find out more about our current special offer,” wherein ‘256’ is the advertiser-specific identifier.

According to an embodiment of the present invention, each of the slots 4, 5, 6 of the card rack may include an illumination means, which illuminates upon entry of the corresponding advertiser-specific identifier to direct the user to the card slot associated with the selected advertiser/product. Alternatively, each card slot may include a button, which the user may push to initiate the display of electronic media related to the selected advertiser/product. In addition, the input device 11 may be used by an individual responsible for maintenance of the main console 20 and/or auxiliary displays 31, 32, such as an administrator, to send other information to the server 9 for further processing, such as, for example, replacement hard-copy promotional item requests and visual display 3, 31, 32 maintenance/repair requests.

One having ordinary skill in the art will appreciate that any suitable input device 11 may be used in accordance with the present invention, including, but not limited to a keypad, a keyboard, a joystick, a reader device, or a voice recognition device.

According to an embodiment of the present invention, the input device 11 may be a reader adapted to read a readable means attached to or embedded within one or more of the hard-copy promotional items (e.g., business cards). For example, a business card may be inserted into the card reader and read by the reader, thereby alerting the server 9 to initiate the display of electronic media related to the selected advertiser/product.

One having ordinary skill in the art will appreciate that the electronic media may be displayed according to a schedule unless a user-initiated request is received. Accordingly, after a user-initiated request is fulfilled, the advertising system 10 may automatically return to its regular programmed schedule of electronic media.

According to an embodiment of the present invention, the input device 11 may be a voice recognition device, adapted to receive and process voice commands. Specifically, the voice recognition device may receive and process a user's orally communicated advertiser-specific identifier.

According to an embodiment of the present invention, the server 9 may include any suitable computer accessible memory capable of storing the electronic media and other related information related to the advertising system, including, but not limited to the location of the one or more main consoles 20 in the environment 50, the frequency and geographic origin of users advertiser-specific requests, hard-copy promotional item tracking data, and visual display 3, 31, 32 performance/maintenance data.

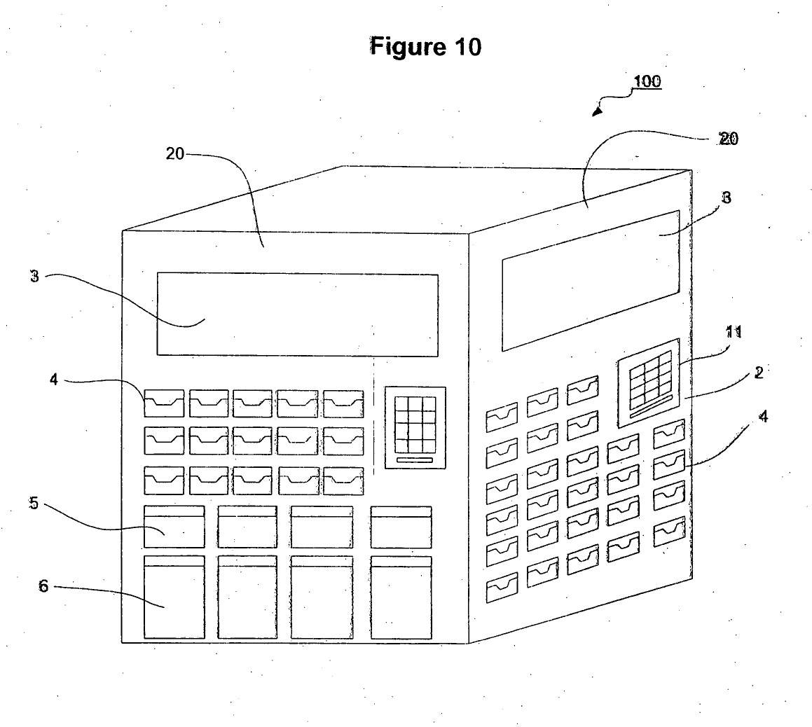

FIG. 10 illustrates an advertising system 100 according to another embodiment of the invention, wherein the advertising system 100 includes a server 9 (not shown) communicatively connected to a plurality of main consoles 20 arranged in a multi-sided configuration. As described above, each main console 20, or side of the multi-sided advertising system 100, may include, but is not limited to, a display rack 2 and a main visual display 3. Advantageously, the multi-sided advertising system 100 may be viewed and operated by a number of viewers or users situated in a 360° space surrounding the advertising system 100. Although the advertising system 100 depicted in FIG. 10 includes four sides, one skilled in the art will appreciate that the advertising system 100 may include any number of sides.

Optionally, the multi-sided advertising system 100 may include an input device 11, as described in detail above. According to another option, the multi-sided advertising system 100 may include one or more auxiliary displays (not shown) situated in visual proximity to one or more sides of the advertising system 100. Advantageously, the multi-sided advertising system 100 may be located in any environment having a number of potential viewing angles and perspectives, including, but not limited to, trade shows, conventions, stadiums, and visitor centers.

One having ordinary skill in the art will appreciate that the main consoles 20 of the advertising systems 1, 10, 100 according to the present invention are scaleable and may be any size. According to an embodiment of the present invention, the main console 20 may be sized in such a manner that it may be arranged on a table top or other similarly sized space. Optionally, particularly for the table top embodiment of the present invention, the base 8 may comprise a swivel to allow the main console 20 to be rotated or turned. According to another embodiment of the present invention, the main console 20 may be mounted on a wall or other surface.

It is to be understood that the exemplary embodiments are merely illustrative of the present invention and that many variations of the above-described embodiments can be devised by one skilled in the art without departing from the scope of the invention. It is therefore intended that all such variations be included within the scope of the invention.

What is claimed is:

1. An advertising method comprising the steps of:
displaying at least one hard-copy promotional item;
providing a main visual display and at least one auxiliary display in visual proximity to the at least one hard-copy promotional item;
serving electronic media to the main visual display and the at least one auxiliary display,
wherein the electronic media is associated with the at least one hard-copy promotional item; and
displaying the electronic media on the main visual display and the at least one auxiliary display.

2. The method of claim 1, wherein the electronic media comprises a video stream.

3. The method of claim 1, wherein the main visual display and the at least one auxiliary display each display a unique segment of the video stream.

4. The method of claim 1, further comprising the step of scheduling the display of the electronic media.

5. The method of claim 1, further comprising the step of allowing a user to select the electronic media to be displayed.

6. The method of claim 5, further comprising the step of selecting the electronic media by entering a advertiser-specific identifier into an input device

7. The method of claim 6, wherein the one or more hard copy promotional items comprise the advertiser-specific identifier.

8. The method of claim 6, wherein at least one of the main visual display and the at least one auxiliary display comprise the advertiser-specific identifier.

9. An advertising system comprising:
a main console including a display rack that displays at least one hard-copy promotional item and a main visual display in visual proximity to the display rack;
at least one auxiliary displays in visual proximity to the main console; and
a server communicatively connected to the main visual display and the at least one auxiliary display, wherein the server is configured to deliver electronic media related to the at least one hard-copy promotional item to the main visual display and the at least one auxiliary display.

10. The advertising system of claim 9, wherein the at least one hard-copy promotional item comprises at least one piece of printed literature.

11. The advertising system of claim 9, wherein the at least one hard-copy promotional item comprises at least one business card.

12. The advertising system of claim 9, wherein the at least one hard-copy promotional item comprises at least one brochure.

13. The advertising system of claim 9, wherein the main console comprises an input device.

14. The advertising system of claim 13, wherein the input device comprises a keypad.

15. The advertising system of claim 13, wherein the input device comprises a card reader.

16. The advertising system of claim 13, wherein the input device comprises a voice recognition reader.

17. The advertising system of claim 9, further comprising a plurality of geographically dispersed main consoles.

18. The advertising system of claim 17, wherein the server delivers the electronic media to the main visual display and the at least one auxiliary display of each main console based at least in part on a geographic location of the main console.

19. An advertising system comprising:
a plurality of main consoles arranged in a multi-sided configuration, wherein each main console includes a display rack that displays at least one hard-copy promotional item and a main visual display in visual proximity to the display rack; and
a server communicatively connected to the plurality of main consoles, wherein the server is configured to deliver electronic media related to the at least one hard-copy promotional item to each of the plurality of main consoles.

20. The advertising system of claim 19, further comprising at least one auxiliary display in visual proximity to at least one of the plurality of main consoles.

21. The advertising system of claim 19, wherein at least one of the plurality of main consoles comprise an input device.

22. The advertising system of claim 22, wherein the input device comprises a keypad.

23. The advertising system of claim 22, wherein the input device comprises a card reader.

24. The advertising system of claim 22, wherein the input device comprises a voice recognition reader.
